(19) United States
(12) Patent Application Publication
(10) Pub. No.: US 2023/0265315 A1
(43) Pub. Date: Aug. 24, 2023

(54) TWO-PART, SILANE MODIFIED POLYMER/FREE RADICALLY CURABLE ADHESIVE SYSTEMS

(71) Applicant: Henkel AG & Holding GmbH, Duesseldorf (DE)

(72) Inventors: Chih-Min Cheng, Westford, MA (US); Jian Lin, Boxborough, MA (US); Christopher J. Verosky, Coventry, CT (US); James M. Murray, Newmarket, NH (US); Daniel Yi, Glastonbury, CT (US); Richard Corrao, Manchester, CT (US); Zachary S. Bauman, West Hartford, CT (US); Ling Li, Glastonbury, CT (US)

(21) Appl. No.: 18/092,792

(22) Filed: Jan. 3, 2023

Related U.S. Application Data
(63) Continuation of application No. PCT/US2021/040226, filed on Jun. 24, 2021.
(60) Provisional application No. 63/047,286, filed on Jul. 2, 2020.
(60) Provisional application No. 63/158,278, filed on Mar. 8, 2021.

(51) Int. Cl. C09J 4/06; C09J 133/12; C09J 11/08; C09J 11/06; C09J 11/04

(52) U.S. Cl. CPC C09J 4/06; C09J 11/04; C09J 11/06; C09J 11/08; C09J 133/12

(57) ABSTRACT

Two-part silane modified polymer/free radically curable adhesive systems demonstrating improved strength and percent elongation are provided.

### BACKGROUND

### Field

Two-part silane modified polymer/free radically curable adhesive systems demonstrating improved strength and percent elongation are provided.

### Brief Discussion of Related Technology

Adhesives containing silane modified polymers (or “SMP”s) are oftentimes used in elastic bonding where high elongation and tensile strength are required. But commercially available SMP adhesives are typically limited to a tensile strength of less than 3 Mpa and an elongation of less than 300%.

Commercial applications demand in some instances higher tensile strength (e.g., 5-8 Mpa) and greater elongation (e.g., > 300%). Surface preparation (e.g., removal of oily contaminants) or treatment (e.g., grinding to facilitate good interfacial adhesion) is also generally needed for SMP adhesives to ensure formation of durable bonds.

In the past, in order to achieve higher tensile strength, percent elongation is ordinarily sacrificed and reactive acrylic adhesives that cure by free radical polymerization of (meth)acrylic esters (i.e., acrylates) are chosen. But these acrylic adhesives suffer from certain drawbacks. Commercially important acrylic adhesives tend to have an offensive odor, particularly those that are made from methyl methacrylate. Methyl methacrylate-based acrylic adhesives also have low flash points (approximately 59° F.). Low flash points are an issue during storage and transportation of the adhesives. If the flash point is 141° F. or lower, the U.S. Department of Transportation classifies the product as “Flammable” and requires marking and special storage and transportation conditions.

U.S. Pat. No. 6,562,181 (Righettini) intends to provide a solution to the problem addressed in the preceding paragraph by describing an adhesive composition comprising: (a) a trifunctional olefinic first monomer comprising an olefinic group that has at least three functional groups each bonded directly to the unsaturated carbon atoms of said olefinic group; (b) an olefinic second monomer that is copolymerizable with the first monomer; (c) a redox initiator system, and (d) a reactive diluent, where the composition is a liquid at room temperature is 100% reactive and substantially free of volatile organic solvent, and is curable at room temperature.

More recently, U.S. Pat. No. 9,371,470 (Burns) describes and claims a two-part curable composition comprising: (a) a first part comprising a cyanoacrylate component and a peroxide catalyst; and (b) a second part comprising a free radical curable component and a transition metal. When mixed together the peroxide catalyst initiates cure of the free radical curable component and the transition metal initiates cure of the cyanoacrylate component.

And U.S. Pat. No. 8,809,479 (Huang) is directed to and claims a moisture-curable resin composition comprising (a) a moisture-curable polymer having at least one hydrolysable silyl group where the polymer is represented by the general Formula (3) :

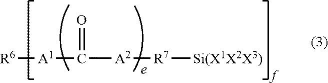

where each occurrence of R⁶ is independently a monovalent or polyvalent organic polymer fragment having a number average molecular weight of from 500 to 25,000 grams per mole and derived from a hydroxyl-terminated polypropylene oxide having a terminal ethylenic unsaturation of less than 0.02 milliequivalents per gram polyol and containing at least one urethane functional group; each occurance of R⁷is independently a divalent alkylene group containing from 1 to 6 carbon atoms; each occurrence of A¹ is divalent oxygen (—O—); each occurrence of A²is substituted nitrogen of the structure —NR⁸—, where R⁸is hydrogen; each occurrence of X¹is independently R⁹O—, wherein each R⁹is independently hydrogen or an alkyl group containing from 1 to 4 carbon atoms; each occurrence of X²and X³is independently selected from the group consisting of R⁹O— and R¹⁰wherein each R⁹ is independently hydrogen or an alkyl group containing from 1 to 4 carbon atoms and each R¹⁰is independently an alkyl group containing from 1 to 4 carbon atoms; and each occurrence of subscripts e and f is independently an integer wherein is 1 and f is 1 to 6; (b) a reactive modifier of the following general formula:

$${\text{G}}^{\text{2}} {\left[- {\text{SiR}}^{4} {}_{c} {\left({\text{OR}}^{5}\right)}_{3 - c}\right]}_{d}$$

where G²is selected from a monovalent or divalent linear hydrocarbon group containing from 3 to 16 carbon atoms; each occurrence of R⁴is monovalent alkyl group containing from 1 to 4 carbon atoms; each occurrence of R⁵ is monovalent alkyl group containing from 1 to 4 carbon atoms; each occurrence of c and d is independently an integer, wherein; c is 0 or 1; and d is 1 or 2 with the provisos that (i) when G²contains a heteroatom, the terminal atoms of G²are carbon atoms; and (ii) when the silicon atom is attached to G², the silicon atom is covalently bonded to a terminal carbon of G²; and (c) at least one catalyst which is a compound selected from organic dibutyltin, zirconium complex, aluminum chelate, titanic chelate, organic zinc, organic cobalt, organic iron, organic nickel, organobismuth and amine catalyzing the reaction between the moisture-curable polymer (a) and reactive modifier under moisture curing conditions; and where component (b) is present in an amount of from 20 percent by weight 40 percent by weight and component (c) is present in an amount of from 0.1 to 3 percent by weight, based upon the total weight of components (a), (b) and (c).

U.S. Pat. Application Publication No. 2015/0027634 (Kohl) is directed to a moisture-curing two-component composition of a component A containing at least one polyoxyalkylene, polyolefin and/or polyacrylate prepolymer having at least one hydrolysable silane group and at least one solid inert additive selected from hydrocarbons, polyesters or polyamides, and a component B contianing at least one crosslinkingcompound for the prepolymer, the two-component composition and component A each having hot-melt adhesive properties.

SMP/epoxy hybrid adhesives are known and are commercially available. For instance, Manus reports that its MANUS-BOND FLEX-WELD has a tensile strength of 5.5 Mpa and a percent elongation of less than 100%. While the tensile strength is suitable, the percent elongation is not for many commercial applications.

Notwithstanding the state of the art, it would be desirable and the need exists to provide an adhesive system having features not found in conventional adhesives, such as improved bond strength together with improved elongation.

### SUMMARY

There is provided in one aspect a two part adhesive composition that comprises:
(a) a Part A composition comprising:
   (i) a (meth)acrylate-functionalized component; and
   (ii) a block copolymer component; and
(b) a Part B composition comprising:
   (i) an alkoxysilane- or acyloxysilane-functionalized component.

The Part A composition or the Part B composition comprises an oxidant and the Part A composition or the Part B composition comprises at least one, desirably both of, a reducing agent and a transition metal, provided that the Part A composition and the Part B composition do not each comprise the oxidant, and the reducing agent and/or the transition metal.

The compositions, which are room temperature curable as the Part A composition and the Part B composition do not interact prior to use on mixing, provide improved bond strength and elongation over conventional adhesive compositions.

More specifically, in some instances, the inventive two part curable compositions have demonstrated a tensile strength of about 4 to about 10 MPa (such as about 5 to about 8 MPa) and a percent elongation of greater than 400, even approaching 500. The combination of high tensile strength and percent elongation observed is better than curable compositions of either of the parts alone, which is surprising and unexpected.

In another aspect, a two part adhesive composition is provided that comprises:
(a) a Part A composition comprising:
   (i) a (meth)acrylate-functionalized component, at least a portion of which comprises an alkyl (meth)acrylate and a mono-functional (meth)acrylate component selected from one or more of isobornyl (meth)acrylate, lauryl (meth)acrylate and/or ethylhexyl (meth)acrylate; and
   (ii) a rubber toughening component comprising one or more of a (meth)acrylate-terminated polybutadiene in liquid form at room temperature, a styrene-butadiene-styrene block copolymer, a styrene-isoprene-styrene block copolymer, hydrogenated styrene-containing copolymer, a core shell rubber, and combinations thereof; and
   (iii)optionally, a reactive acid component comprising one or more of (meth)acrylic acid and/or phosphate ester of hydroxyethyl methacrylate; and
(b) a Part B composition comprising:
   (i) an alkoxysilane- or acyloxysilane-functionalized component, where the Part A composition or the Part B composition comprises an oxidant and the Part A composition or the Part B composition comprises at least one, desirably both, of a reducing agent and a transition metal, provided that the Part A composition and the Part B composition do not each comprise the oxidant, and the reducing agent and/or the transition metal.

And in a further aspect there is provided a two part adhesive composition that comprises:
(a) a Part A composition comprising:
   (i) a (meth)acrylate-functionalized component;
   (ii) a (meth)acrylate-functionalized urethane; and
   (iii)a block copolymer component; and
(b) a Part B composition comprising:
   (i) an alkoxysilane- or acyloxysilane-functionalized component.

The Part A composition or the Part B composition comprises an oxidant and the Part A composition or the Part B composition comprises at least one, desirably both of, a reducing agent and a transition metal, provided that the Part A composition and the Part B composition do not each comprise the oxidant, and the reducing agent and/or the transition metal.

Here, the two part adhesive composition when dispensed is capable of curing in a fixture time on aluminum substrates with a 1 mm gap of about 15 to about 45 minutes. And when cured the two part adhesive composition here demonstrates at least one of a tensile strength on aluminum substrates of greater than 2.5 MPa, and percent elongation of greater than 100.

### DETAILED DESCRIPTION

As noted above, there is provided in a first aspect a two part adhesive composition that comprises:
(a) a Part A composition comprising:
   (i) a (meth)acrylate-functionalized component; and
   (ii) a block copolymer component; and
(b) a Part B composition comprising:
   (i) an alkoxysilane- or acyloxysilane-functionalized component.

The Part A composition or the Part B composition comprises an oxidant and the Part A composition or the Part B composition comprises at least one, desirably both of, a reducing agent and a transition metal, provided that the Part A composition and the Part B composition do not each comprise the oxidant, and the reducing agent and/or the transition metal.

In a second aspect, a two part adhesive composition is provided that comprises:
(a) a Part A composition comprising:
   (i) a (meth)acrylate-functionalized component, at least a portion of which comprises an alkyl (meth)acrylate and a mono-functional (meth)acrylate component selected from one or more of isobornyl (meth)acrylate, lauryl (meth)acrylate and/or ethylhexyl (meth)acrylate; and
   (ii) a rubber toughening component comprising one or more of a (meth)acrylate-terminated polybutadiene in liquid form at room temperature, a styrene-butadiene-styrene block copolymer, a styrene-isoprene-styrene block copolymer, hydrogenated styrene-containing copolymer, a core shell rubber, and combinations thereof; and
   (iii)optionally, a reactive acid component comprising one or more of (meth)acrylic acid and/or phosphate ester of hydroxyethyl methacrylate; and
(b) a Part B composition comprising:
   (i) an alkoxysilane- or acyloxysilane-functionalized component, where the Part A composition or the Part B composition comprises an oxidant and the Part A composition or the Part B composition comprises at least one, desirably both, of a reducing agent and a transition metal, provided that the Part A composition and the Part B composition do not each comprise the oxidant, and the reducing agent and/or the transition metal.

In a third aspect, there is provided a two part adhesive composition that comprises:
(a) a Part A composition comprising:
   (i) a (meth)acrylate-functionalized component;
   (ii) a (meth)acrylate-functionalized urethane; and
   (iii)a block copolymer component; and
(b) a Part B composition comprising:
   (i) an alkoxysilane- or acyloxysilane-functionalized component.

The Part A composition or the Part B composition comprises an oxidant and the Part A composition or the Part B composition comprises at least one, desirably both of, a reducing agent and a transition metal, provided that the Part A composition and the Part B composition do not each comprise the oxidant, and the reducing agent and/or the transition metal.

Here, in the third aspect, the two part adhesive composition when dispensed is capable of curing in a fixture time on aluminum substrates with a 1 mm gap of about 15 to about 45 minutes. And when cured the two part adhesive composition here demonstrates at least one of a tensile strength on aluminum substrates of greater than 2.5 MPa, and percent elongation of greater than 100.

### Part A Composition

The (meth)acrylate-functionalized component (i) of the Part A composition comprises an alkyl (meth)acrylate and/or a mono-functional (meth)acrylate component, according to the first aspect. The (meth)acrylate-functionalized component (i) of the Part A composition may comprise an alkyl (meth)acrylate together with one or more of isobornyl (meth)acrylate, lauryl (meth)acrylate and/or ethylhexyl (meth)acrylate, according to the second aspect.

The alkyl (meth)acrylate may be chosen from a host of (meth)acrylates, with some being aromatic, while others are aliphatic and still others are cycloaliphatic. Examples of such alkyl (meth)acrylates include di-or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), bisphenol-F mono and di(meth)acrylates, such as ethoxylated bisphenol-F (meth)acrylate, (meth)acrylate-functionalized urethanes and hydroxyalkyl(meth)acrylate, among others.

The hydroxy alkyl(meth)acrylates include 2-hydroxyethyl(meth)acrylate, phenoxyethyl(meth)acrylate, N-vinyl caprolactam, N,N-dimethyl acrylamide, 2(2-ethoxyethoxy) ethyl acrylate, caprolactone acrylate, polypropylene glycol monomethacrylate, 1,3-butylene glycol dimethacrylate, 1,4-butanediol dimethacrylate, 1,6 hexanediol di(meth)acrylate, tricyclodecane dimethanol di(meth)acrylate, tripropylene glycol di(meth)acrylate, ethoxylated trimethylolpropane tri(meth)acrylate, trimethylolpropane tri(meth)acrylate, tris(2-hydroxy ethyl) isocyanurate tri(meth)acrylate, and combinations thereof.

In addition, 1,4-butanediol dimethacrylate, 1,6 hexanediol di(meth)acrylate, tricyclodecane dimethanol di(meth)acrylate, tripropylene glycol diacrylate, ethoxylated trimethylolpropane triacrylate, trimethylolpropane triacrylate, and tris(2-hydroxy ethyl) isocyanurate triacrylate may be used.

The alkyl and/or mono-functional (meth)acrylate component should be used in an amount within the range of about 10 to about 50 percent by weight, such as about 15 to about 30 percent by weight, based on the total weight of the (meth)acrylate-functionalized component.

The block copolymer component (ii) of the Part A composition in the first and second aspects particularly may comprise one or more of a (meth)acrylate-terminated polybutadiene in liquid form at room temperature, a styrene-containing block copolymer, a core shell rubber, and combinations thereof. The styrene-containing block copolymer may be selected from styrene-butadiene-styrene (“SBS”), styrene-isoprene-styrene (“SIS”), hydrogenated styrene-containing copolymer (“SEES”) and combinations thereof. The SBS and SIS block copolymers should have a weight average molecular weight of at least about 100,000 Mw, such as in the range of about 100,000 to about 500,000 Mw, desirably about 100,000 to about 200,000 Mw.

Commercially available examples of such block copolymers may be obtained from Kraton Corporation, Houston, TX under the trade name KRATON, such as KRATON D1114, D1115 and D1155. The block copolymer component may be used in an amount of from about 5 to about 25 percent by weight, based on the total of the Part A and the Part B compositions.

A commercially available example of a core shell rubber is CLEARSTRENGTH XT100, available commercially from Arkema Inc., Cary, NC and described as a methyl methacrylate-butadiene-styrene core-shell toughening agent, which is compatible with various monomers and easily dispersible in most liquid resin systems, and exhibits a limited impact on their viscosity while providing a toughening effect over a wide range of service temperatures.

The (meth)acrylate-functionalized urethane in the third aspect of the Part A composition may include a host of materials.

For instance, the (meth)acrylate-functionalized urethane may be in the form of a multi- (such as di- or tri-) functional urethane acrylate oligomer, more desirably an aliphatic polyether urethane acrylate. An example of a suitable (meth)acrylate-functionalized urethane is BR-582E8 (commercially available from Dymax Corporation, Torrington, CT), which is described as an aliphatic urethane acrylate oligomer having a polyether backbone. BOMAR BR-582E8 is said by the manufacturer to provide a balance of toughness and flexibility. Dymax recommends this product for use in single-coat, flexible coatings on metal and plastic substrates and is an excellent choice for impact and bend resistant coatings, demonstrating abrasion resistance, flexibility, gloss, hydrolytic stability, weather resistance and non-yellowing properties too. Dymax reports the product to have a Tg by DMA of 23° C. and a nominal viscosity of 60,000 cP at 50° C., and to bond to a variety of substrates, though not to high density polyethylene. BR-582E8 is listed in the tables below.

Dymax also makes available commercially a series of other (meth)acrylate-functionalized urethanes, which have a functionality of between about 1 and about 3, and demonstrate a percent elongation of greater than about 50. One such (meth)acrylate-functionalized urethane from Dymax is a tri-functional urethane acrylate oligomer, more specifically an aliphatic polyether urethane triacrylate, known as BR-990.

Among the (meth)acrylate-functionalized urethanes are those based on polyesters or polyethers, which are reacted with aromatic, aliphatic, or cycloaliphatic diisocyanates and capped with hydroxy acrylates.

For instance, difunctional urethane acrylate oligomers, such as a polyester of hexanedioic acid and diethylene glycol, terminated with isophorone diisocyanate, capped with 2-hydroxyethyl acrylate (CAS 72121-94-9); a polypropylene glycol terminated with tolyene-2,6-diisocyanate, capped with 2-hydroxyethylacrylate (CAS 37302-70-8); a polyester of hexanedioic acid and diethylene glycol, terminated with 4,4′-methylenebis(cyclohexyl isocyanate), capped with 2-hydroxyethyl acrylate (CAS 69011-33-2); a polyester of hexanedioic acid, 1,2-ethanediol, and 1,2 propanediol, terminated with tolylene-2,4-diisocyanate, capped with 2-hydroxyethyl acrylate (CAS 69011-31-0); a polyester of hexanedioic acid, 1,2-ethanediol, and 1,2 propanediol, terminated with 4,4′-methylenebis(cyclohexyl isocyanate, capped with 2-hydroxyethyl acrylate (CAS 69011-32-1); and a polytetramethylene glycol ether terminated with 4,4′-methylenebis(cyclohexylisocyanate), capped with 2-hydroxyethyl acrylate.

The following commercially available (meth)acrylate-functionalized urethane resins from Dymax that may be useful include BR-930D [described by the manufacturer as a polyether urethane acrylate that is flexible and has weatherability, with a nominal viscosity of 7,700 at 60° C. and a Tg (°C) by DMA of 95. The manufacturer promotes BR-930D as having the following features for select applications ideal for 3D printing resins; high heat-distortion temperature; provides good toughness and impact resistance; enhances weatherability and low skin irritation]; and BR 7432G130 [described by the manufacturer as a polyester urethane acrylate that is flexible and has weatherability, with a nominal viscosity of 80,000 at 25° C. and a Tg (°C) by DMA of 28. The manufacturer promotes BR-7432G130 as having the following features for select applications: imparts toughness; high tensile strength; improves impact resistance; adheres to polymer films; elastomeric; and BR-3741AJ [described by the manufacturer as a polyether urethane acrylate that is flexible and has weatherability, with a nominal viscosity of 25,000 at 60° C. and a Tg (°C) by DMA of -50. The manufacturer promotes BR-3741AJ as having the following features for select applications: enhances softness and flexibility; improved optical clarity; non-yellowing; improves adhesion; adheres to a wide range of substrates; exhibits hydrolytic stability; oil and chemical resistant and ideal for PSAs].

Other examples of such (meth)acrylate-functionalized urethanes include a tetramethylene glycol urethane acrylate oligomer and a propylene glycol urethane acrylate oligomer.

Still other (meth)acrylate-functionalized urethanes are monofunctional urethane acrylate oligomers, such as a polypropylene terminated with 4,4′-methylenebis(cyclohexylisocyanate), capped with 2-hydroxyethyl acrylate and 1-dodosanol.

They also include difunctional urethane methacrylate oligomers such as a polytetramethylene glycol ether terminated with tolulene-2,4-diisocyanate, capped with 2-hydroxyethyl methacrylate; a polytetramethylene glycol ether terminated with isophorone diisocyanate, capped with 2-hydroxyethyl methacrylate; a polytetramethylene glycol ether terminated with 4,4′-methylenebis(cyclohexylisocyanate), capped with 2-hydroxyethyl methacrylate; and a polypropylene glycol terminated with tolylene-2,4-diisocyanate, capped with 2-hydroxyethyl methacrylate.

Other suitable (meth)acrylate-functionalized urethanes include those disclosed in U.S. Pat. Nos. 4,018,851, 4,295,909 and 4,309,526 to Baccei, and U.S. Pat. Nos. Re 33,211, 4,751,273, 4,775,732, 5,019,636 and 5,139,872 to Lapin et al.

Thus, (meth)acrylate-functionalized urethanes may be chosen from a variety of materials, some of which are commercially available from Dymax and are recited below in the tables together with certain salient features:

Polyester Urethane Acrylates

| Name | Functionality | Elongation at Break, % |
|---|---|---|
| BR-744BT | 2 | 407 |
| BR-744SD | 2 | 321 |
| BR-7432GB | 2 | 350 |
| BR-7432GI30 | 2 | 260 |

Polyester Urethane Methacrylates

| Name | Functionality | Elongation at Break, % |
|---|---|---|
| BR-742M | 2 | 60 |
| BR-742MS | 2 | 60 |

Polyether Urethane Acrylates

| Name | Functionality | Elongation at Break, % |
|---|---|---|
| BR-302 | 2 | 102.5 |
| BR-343 | 2 | 57 |
| BR-344 | 2 | 110 |
| BR-345 | 2 | 260 |
| BR-372 | 2 | 90 |
| BR-374 | 2 | 285 |
| BR-541S | 2 | 120 |
| BR-543 | 2 | 200 |
| BR-571 | 2 | 115 |
| BR-582E8 | 2.4 | 180 |
| BR-582H15 | 2.4 | 65 |
| BR-582110 | 2.4 | 180 |
| BR-3042 | 2 | 500 |
| BR-3641AA | 1.3 | 580 |
| BR-3641AJ | 1.3 | 2,900 |
| BR-3741 | 2 | 152 |
| BR-3741AJ | 1.3 | 1,000 |
| BR-5825130 | 2.4 | 130 |

Polyether Urethane Methacrylates

| Name | Functionality | Elongation at Break, % |
|---|---|---|
| BR-116 | 3 | 57 |
| BR-202 | 2 | 75 |
| BR-204 | 2 | 160 |
| BR-541MB | 2 | 63 |
| BR-543MB | 2 | 51 |
| BR-551M | 2 | 74 |
| BR-551ME | 2 | 60 |
| BR-571MB | 2 | 110 |
| XR-145S | 3 | 140 |

As an example, the BR-345 (meth)acrylate-functionalized urethane may be made according to the following reaction scheme:

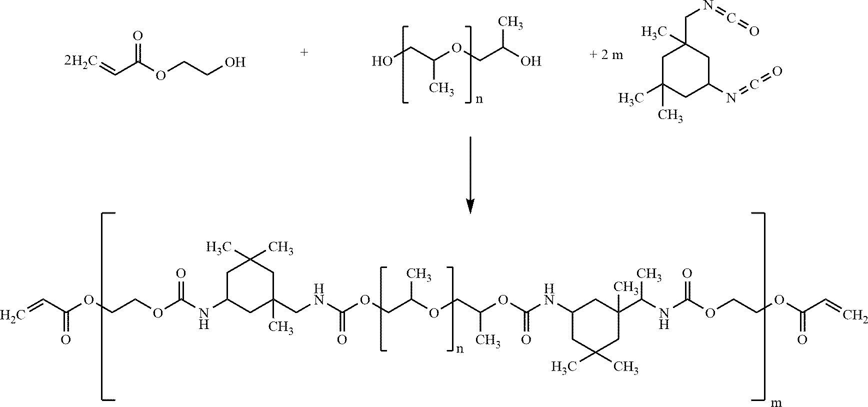

Another example of a useful (meth)acrylate-functionalized urethane is a block resin noted as cyclohexanol, 4,4-(1-methylethylidene)bis-, polymer with 1,3-disocyanatomethylbenzene and tetrahydrofuran, propylene glycol monomer (CAS No. 2243075-64-9), made in sequential steps from the reaction of the propylene glycol monomer and dicarboxylic acids to form polyester diols, followed by reaction with toluene diisocyanate and finally capping with hydroxy propyl(meth)acrylate.

Still another example of a useful (meth)acrylate-functionalized urethane is a block resin made from a saturated polyester diol (such as one sold under the tradename DESMOPHEN S-1011-35) and dicyclohexylmethane-4,4′-diisocyanate (available commercially as DESMODUR W), and capping with 2-hydroxy ethyl acrylate, the block resin being diluted with IBOA. This block resin is referred to in the Examples as Resin A.

Resin B, containing a central segment of POLYMEG 2000 (polytetramethylene ether glycol produced by polymerizing tetrahydrofuran to form a linear diol with a backbone of repeating tetramethylene units connected by ether linkages, and capped with primary hydroxyl units) to which are attached through urethane linkages either TDI—HBPA or IPDTI-HMTD and capped with either TDI-HMPA or IPDI-HEMA; Resin C, made from a hydroxy functionalized polyether, polyester (available commercially as KURARAY Polyol P-2010) and TDI, together with hydroxypropyl (meth)acrylate and isobornyl (meth)acrylate; and Resin D, made from polyTHF (with a Mw of 2,000) and TDI, together with HBPA, hydroxypropyl (meth)acrylate, hydroxyethyl (meth)acrylate and isobornyl (meth)acrylate, while not used in the Examples, are well suited.

In some cases, such as described in U.S. Pat. No. 10,745,590, hydrophobic (meth)acrylate-functionalized urethanes may be desirable, such as those having a weight average molecular weight (“Mw”) of 35000 to 60000 g/mol, as determined by gel permeation chromatography (“GPC”). With the Mw falling within this range, the cured products may also demonstrate strong cohesion and high elongation. Preferably, hydrophobic (meth)acrylate-functionalized urethanes should have a functionality of the (meth)acrylate group of equal to or less than 2. With the functionality of the (meth)acrylate group falling within this range, the cured products may also demonstrate high elongation. These hydrophobic (meth)acrylate-functionalized urethanes should have a glass transition temperature value (“Tg”) of from -60° C. to 20° C., as determined by differential scanning calorimetry (“DSC”).

Hydrophobic (meth)acrylate-functionalized urethanes may be selected from aliphatic urethane (meth)acrylates, aromatic urethane (meth)acrylates and mixtures thereof, such as polybutadiene based urethane (meth)acrylates, polyisobutylene based urethane (meth)acrylates, polyisoprene based urethane (meth)acrylate, polybutyl rubber based urethane (meth)acrylates and the mixtures thereof. Suitable commercially available hydrophobic urethane (meth)acrylates include UT-4462 and UV36301B90 available from Nippon Gohsei; CN 9014 available from Sartomer; and SUO-H8628 available from SHIIN-A T&C.

Suitable (meth)acrylate-functionalized urethanes also include oligomers having a number average molecular weight (“Mn”) of from about 500 to about 100000, as determined by GPC.

(Meth)acrylate-functionalized urethanes may also include polyurethane block copolymer having a backbone of alternating hard and soft segments and at least two ends. The ends each may be terminated with a vinyl ether, alkenyl ether or (meth)acrylate group. Such polyurethane block copolymers may be represented by the following general formula:

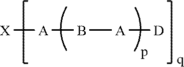

wherein A is a hard segment, such as the reaction product of a polyisocyanate and an aromatic, heterocyclic or cycloaliphatic polyol;
B is a divalent soft segment and X is a q-valent soft segment, such as where B and X may be a divalent and a multivalent group, respectively, derived from a polyether polyol, polyester polyol or hydrogenated hydrocarbon elastomer, such as polybutadiene;
D is a vinyl ether or (meth)acrylate group, such as where the vinyl ether may be derived from hydroxy functional vinyl ethers, for instance 2-hydroxyethyl vinyl ether, 4-hydroxybutyl vinyl ether, cyclohexanedimethanol monovinyl ether, diethylene glycol monovinyl ether, 1,6-hexanediol monovinyl ether and 3-aminopropyl vinyl ether, or the vinyl ether terminal groups may be derived from an amino functional vinyl ether, in which case vinyl ether urea capped polyurethanes may be obtained;
p is 0-10; and
q is 2-6.

Another example of a (meth)acrylate-functionalized urethane is one with a polyurethane backbone, at least a portion of which includes a urethane linkage formed from isophorane diisocyanate. For instance, such a (meth)acrylate-functionalized urethane is made from an alkylane glycol (such as polypropylene glycol), isophorane diisocyanate and hydroxy alkyl(meth)acrylate (such as hydroxyl ethyl acrylate). Other examples include a polyester of hexanedioic acid, diethylene glycol, terminated with isophorone diisocyanate, capped with 2-hydroxyethyl acrylate; a polytetramethylene glycol ether terminated with isophorone diisocyanate, capped with 2-hydroxyethyl methacrylate; and a hydroxy terminated polybutadiene terminated with isophorone diisocyanate, capped with 2-hydroxyethyl acrylate.

The (meth)acrylate-functionalized urethane should be present in an amount from about 18 percent by weight to about 45 percent by weight, such as from about 20 percent by weight to about 40 percent by weight, for example from about 26 percent by weight to about 38 percent by weight by weight, based on the total weight of the Part A composition, in this aspect.

Alkyl (meth)acrylates useful in making the (meth)acrylate-functionalized urethanes include isobornyl(meth)acrylate, isodecyl(meth)acrylate, lauryl(meth)acrylate, cyclic trimethylolpropane formal acrylate, octyldecyl acrylate, tetrahydrofurfuryl(meth)acrylate, tridecyl(meth)acrylate, and hydroxy alkyl(meth)acrylates, among others.

Hydroxy alkyl(meth)acrylates used to cap the so-formed (meth)acrylate functionalized urethanes include 2-hydroxyethyl(meth)acrylate, phenoxyethyl(meth)acrylate, N-vinyl caprolactam, N,N-dimethyl acrylamide, 2 (2-ethoxyethoxy) ethyl acrylate, caprolactone acrylate, polypropylene glycol monomethacrylate, 1,3-butylene glycol dimethacrylate, 1,4-butanediol dimethacrylate, 1,6 hexanediol di(meth)acrylate, tricyclodecane dimethanol di(meth)acrylate, tripropylene glycol diacrylate, ethoxylated trimethylolpropane triacrylate, trimethylolpropane triacrylate, tris(2-hydroxy ethyl) isocyanurate triacrylate, and combinations thereof.

The Part A composition may also comprise a reactive acid component, which may be one or more of (meth)acrylic acid and/or (meth) acrylic acid ester, such as phosphoric acid esters, phosphate acid esters, and sulfonic acids or derivatives. A preferred reactive acid component is a phosphate acid ester.

Suitable phosphate acid esters include those represented by the formula:

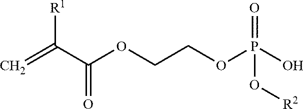

where here R is H or CH₃, and R is H or a radical represented by the structure:

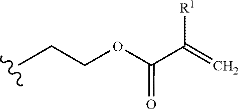

where here R¹is H or CH₃.

A particularly useful phosphate ester is 2-hydroxyl ethyl methacrylate (“HEMA”) phosphate ester, which is sold under the tradename HARCRYL, available from Harcros Chemicals, Kansas City,KS.

The reactive acid component, if used, is present in up to about 5 percent to 10 percent by weight, desirably, about 0.1 to about 3 percent by weight.

### Part B Composition

The alkoxysilane- or acyloxysilane-functionalized component of the Part B composition may be a polymer having at least one hydrolysable silyl group that is bonded to the polymer chain through an ether (—O—) linking group or carbonyl group, in which the carbonyl is bonded to heteroatoms selected from oxygen, nitrogen and sulfur, with the proviso that at least one heteroatom is nitrogen.

For instance, the alkoxysilane- or acyloxysilane-functionalized component may be embraced by polymers within the following structure:

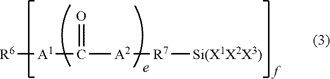

where each occurrence of R⁶is independently a monovalent or polyvalent organic polymer fragment having a number average molecular weight of from 500 to 25,000 grams per mole (g/mol); each occurrence of R⁷is independently a divalent hydrocarbylene group containing from 1 to 12 carbon atoms which is selected from divalent alkylene, alkenylene, arenylene, arylene and aralkylene, and, optionally, the divalent hydrocarbylene group contains at least one heteroatom selected from oxygen, nitrogen and sulfur, each occurrence of A²is independently selected from divalent oxygen (—O—), sulfur (S-) or substituted nitrogen of the structure (-)-NR, where R is hydrogen, alkyl, alkenyl, arenyl, aryl, aralkyl or R′SiXXX group, where each R′, when not hydrogen, contains from 1 to 18 carbon atoms, and with the proviso that when A′ is oxygen or sulfur, then A is (-)-NR and when e is 0, then A′ is oxygen; each occurrence of A is independently selected from divalent oxygen (—O—), sulfur (S-) or substituted nitrogen of the structure (-)-NR, NR(C═O)NR, NR(C═O)C, and NR(C═O)S, where R is hydrogen, alkyl, alkenyl, arenyl, aryl, aralkyl or R′SiXXX group, where each R′, when not hydrogen, contains from 1 to 18 carbon atoms, and with the proviso that when A is oxygen or sulfur, then A′ is (-)-NR; each occurrence of X is independently RO, where each R is independently selected from hydrogen, alkyl, alkenyl, arenyl, aryl, and aralkyl groups, where each R, when not hydrogen, contains from 1 to 18 carbon atoms and, optionally, contains at least one oxygen or sulfur atom; each occurrence of X and X is independently selected from RO and R″, where each R is independently selected from hydrogen, alkyl, alkenyl, arenyl, aryl, and aralkyl, where each R, when not hydrogen, contains from 1 to 18 carbon atoms and, optionally, contains at least one oxygen or sulfur atom and each R″ is independently an alkyl group containing from 1 to 6 carbon atoms; and each occurrence of e and f is independently an integer, where e is 0 or 1 and f is 1 to 6.

The alkoxysilane- or acyloxysilane-functionalized component may be present in the composition in an amount of from about 30 percent by weight to about 95 percent by weight, such as an amount of from about 50 percent by weight to about 90 percent by weight, desirably an amount of from about 60 percent by weight to about 80 percent by weight based on the total weight of the Part B composition components.

The alkoxysilane- or acyloxysilane-functionalized component may be prepared from a polyol reactant or a combination of polyol reactants. Combinations of polyol reactants are often used to achieve specific physical properties of the alkoxysilane- or acyloxysilane-functionalized component, such as flowability, tensile, modulus and adhesion. The number average molecular weight of the polyol reactant is specifically from 300 to 24,000 grams per mole (g/mol), and more specifically from 1,000 to 20,000 grams per mole.

The average hydroxyl-functionality of the polyol reactant mixture is specifically from 1.6 to 6.0 hydroxyl group per polyol molecule, more specifically from 1.8 to 3.0 hydroxyl group per polyol molecule and most specifically, from 1.95 to 2.5 hydroxyl groups per polyol molecule.

The alkoxysilane- or acyloxysilane-functionalized component may be prepared from a blend of a low number average molecular weight polyol reactant and a high number average molecular weight polyol reactant. The alkoxysilane- or acyloxysilane-functionalized component prepared from this blend of polyol reactants after cure and at low strains has a high modulus, while maintaining high values for percent elongation at break.

The number average molecular weight of the low molecular weight polyol should be from 300 to 2,000 grams per mole, such as from 500 to 1,200 grams per mole and desirably from 800 to 1,000 grams per mole. The number average molecular weight of the high molecular weight polyol is specifically from 2,000 to 24,000 grams per mole, more specifically from 4,000 to 12,000 grams per mole and most specifically from 8,000 to 10,000 grams per mole. The weight ratio of low molecular weight polyol reactant to high molecular weight polyol reactant is specifically from 0.01 to 3, more specifically from 0.05 to 1 and most specifically from 0.2 to 0.5. Representative non-limiting examples of polyols include hydroxyl-terminated polyalkylene oxides, such as hydroxyl terminated polypropylene oxide, hydroxyl-terminated poly ethylene oxide, and hydroxyl-terminated polybutylene oxide: polyoxyalkylene triols; polycaprolactone diols and triols; hydroxyl terminated unsaturated rubbers, such as hydroxyl terminated polybutane diene copolymer, polyester diols and polyol made from Saturated aliphatic diacids and diols or triols, unsaturated diacids and diols or triols, saturated poly acids and diols or aromatic diacids and diols or triols and the like; polytetramethylene glycols; and other diols or triols.

These polyols may have a very low unsaturation level and therefore high functionality. The polyols are typically prepared using metal complex catalysts for the polymerization of alkylene oxide resulting in polyols having a low level of terminal ethylenic unsaturation. The number average molecular weight of the polyols is specifically in the range between from 500 and 24,000 grams per mole and more specifically from 2000 to 12,000 grams per mole.

An alkoxysilane- or acyloxysilane-functionalized component containing one silyl group can be used in combination with an alkoxysilane- or acyloxysilane-functionalized component containing two or more silyl groups to lower the Tg and increase the flexibility of the alkoxysilane-or acyloxysilane-functionalized component in total.

The alkoxysilane- or acyloxysilane-functionalized component may be used in an amount of from about 35 to about 70 percent by weight, based on the total of the Part A composition and the Part B composition.

The oxidant may be a peroxide, such as a perbenzoate (such as t-butyl perbenzoate), benzoyl peroxide (“BPO”) or cumene hydroperoxide.

The oxidant may be used in an amount of from about 0.5 to about 7.5 percent by weight, based on the total of the Part A composition and the Part B composition.

The reducing agent may be present in an amount of about 0.25 to about 5 percent by weight, based on the total of the Part A composition and the Part B composition. Oftentimes, nitrogen containing components are used as the reducing agent, such as dihydropyridine derivatives, such as dihydrophenylpyridine (also referred to as phenyldihydropyridine or “PDHP”), dimethyl-para-toluene (“DMpT”), dihydroquinoline, dihydroisoquinoline, or other readily oxidized partially aromatic nitrogen containing compounds. A preferred dihydropyridine additive is that prepared from the condensation of butyraldehyde and aniline, which forms 3,5-diethyl-1,2-dihydro-1-phenyl-2-propylpyridine, a PDHP product. Commercially available forms of PDHP include REILLCAT P50 and REILLY PDHP by Vertellus Specialties, Inc., Indianapolis, IN; from R.T. Vanderbilt under the tradename VANAX 808; and VULKACIT 576 from Lanxess Corp.

The reducing agent may be used in an amount of from about 0.25 to about 5 percent by weight, based on the total of the Part A composition and the Part B composition.

As noted, a transition metal is also present when the reducing agent is a nitrogen containing component. A non-exhaustive list of representative examples of the transition metal compounds are copper, vanadium, cobalt and iron compounds.

For instance, as regards copper compounds, copper compounds where copper enjoys a 1+ or 2+ valence state are desirable. A non-exhaustive list of examples of such copper (I) and (II) compounds include copper (II) 3,5-diisopropylsalicylate hydrate, copper bis(2,2,6,6-tetramethyl-3,5-heptanedionate), copper (II) hydroxide phosphate, copper (II) chloride, copper (II) acetate monohydrate, tetrakis(acetonitrile)copper (I) hexafluorophosphate, copper (II) formate hydrate, tetrakisacetonitrile copper (I) triflate, copper(II)tetrafluoroborate, copper (II) perchlorate, tetrakis(acetonitrile)copper (I) tetrafluoroborate, copper (II) hydroxide, copper (II) hexafluoroacetylacetonate hydrate and copper (II) carbonate. These copper (I) and (II) compounds should be used in an amount such that when dissolved or suspended in a carrier vehicle, such as a (meth)acrylate, a concentration of about 100 ppm to about 5,000 ppm, such as about 500 ppm to about 2,500 ppm, for instance about 1,000 ppm is present in the solution or suspension.

As regards vanadium compounds, vanadium compounds where vanadium enjoys a 2+ and 3+ valence state are desirable. Examples of such vanadium (III) compounds include vanadyl naphthanate and vanadyl acetylacetonate. These vanadium (III) compounds should be used in an amount of 50 ppm to about 5,000 ppm, such as about 500 ppm to about 2,500 ppm, for instance about 1,000 ppm.

As regards cobalt compounds, cobalt compounds where cobalt enjoys a 2+ valence state are desirable. Examples of such cobalt (II) compounds include cobalt naphthenate, cobalt tetrafluoroborate and cobalt acetylacetonate. These cobalt (II) compounds should be used in an amount of about 100 ppm to about 1000 ppm.

As regards iron compounds, iron compounds where iron enjoys a 3+ valence state are desirable. Examples of such iron (III) compounds include iron acetate, iron acetylacetonate, iron tetrafluoroborate, iron perchlorate, and iron chloride. These iron compounds should be used in an amount of about 100 ppm to about 1000 ppm.

The transition metal may be used in an amount of from about 0.005 percent by weight (or 50 ppm) to about 0.5 percent by weight (or 5000 ppm).

After mixing together the Part A composition and the Part B composition of the first aspect, the composition cures to 90% of its ultimate strength in about 24 hours at room temperature. When cured, the composition demonstrates at least one of lap shear strength on aluminum substrates of greater than about 2.5 MPas, linear shrinkage of less than about 8%, Shore A hardness of greater than about 40, and percent elongation of greater than 200%.

Additives may be included in either or both of the Part A composition or the Part B composition to influence a variety of performance properties.

For instance, fillers may be uses, including, for example, aluminum nitride, boron nitride, silicon carbide, diamond, graphite, beryllium oxide, magnesia, silicas, such as fumed silica or fused silica, alumina, perfluorinated hydrocarbon polymers (i.e., TEFLON), thermoplastic polymers, thermoplastic elastomers, mica, glass powder and the like. Preferably, the particle size of these fillers will be about 20 microns or less.

As regards silicas, the silica may have a mean particle diameter on the nanoparticle size; that is, having a mean particle diameter on the order of 10⁻⁹ meters. The silica nanoparticles can be pre-dispersed in epoxy resins, and may be selected from those available under the tradename NANOPOCRYL, from Nanoresins, Germany. NANOCRYL is a tradename for a product family of silica nanoparticle reinforced (meth)acrylates. The silica phase consists of surface-modified, synthetic SiO₂ nanospheres with less than 50 nm diameter and an extremely narrow particle size distribution. The SiO₂nanospheres are agglomerate-free dispersions in the (meth)acrylate matrix resulting in a low viscosity for resins containing up to 50 percent by weight silica.

Rubber particles, especially rubber particles that have relatively small average particle size (e.g., less than about 500 nm or less than about 200 nm), may also be included, particularly in the Part A composition. The rubber particles may or may not have a shell common to known core-shell structures.

In the case of rubber particles having a core-shell structure, such particles generally have a core comprised of a polymeric material having elastomeric or rubbery properties (i.e., a glass transition temperature less than about 0° C., e.g., less than about -30° C.) surrounded by a shell comprised of a non-elastomeric polymeric material (i.e., a thermoplastic or thermoset/crosslinked polymer having a glass transition temperature greater than ambient temperatures, e.g., greater than about 50° C.). For example, the core may be comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) while the shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature. Other rubbery polymers may also be suitably be used for the core, including polybutylacrylate or polysiloxane elastomer (e.g., polydimethylsiloxane, particularly crosslinked polydimethylsiloxane).

Typically, the core will comprise from about 50 to about 95 percent by weight of the rubber particles while the shell will comprise from about 5 to about 50 percent by weight of the rubber particles.

Preferably, the rubber particles are relatively small in size. For example, the average particle size may be from about 0.03 to about 2 microns or from about 0.05 to about 1 micron. The rubber particles may have an average diameter of less than about 500 nm, such as less than about 200 nm. For example, the core-shell rubber particles may have an average diameter within the range of from about 25 to about 200 nm.

When used, these core shell rubbers allow for toughening to occur in the composition and oftentimes in a predictable manner -- in terms of temperature neutrality toward cure -- because of the substantial uniform dispersion, which is ordinarily observed in the core shell rubbers as they are offered for sale commercially.

In the case of those rubber particles that do not have such a shell, the rubber particles may be based on the core of such structures.

Desirably, the rubber particles are relatively small in size. For example, the average particle size may be from about 0.03 to about 2 µ or from about 0.05 to about 1 µ. In certain embodiments of the invention, the rubber particles have an average diameter of less than about 500 nm. In other embodiments, the average particle size is less than about 200 nm. For example, the rubber particles may have an average diameter within the range of from about 25 to about 200 nm or from about 50 to about 150 nm.

The rubber particles may be used in a dry form or may be dispersed in a matrix, as noted above.

Typically, the composition may contain from about 5 to about 35 percent by weight rubber particles.

Combinations of different rubber particles may advantageously be used in the present invention. The rubber particles may differ, for example, in particle size, the glass transition temperatures of their respective materials, whether, to what extent and by what the materials are functionalized, and whether, to what extent and how their surfaces are treated.

Rubber particles that are suitable for use in the present invention are available from commercial sources. For example, rubber particles supplied by Eliokem, Inc. may be used, such as NEP R0401 and NEP R401S (both based on acrylonitrile/butadiene copolymer); NEP R0501 (based on carboxylated acrylonitrile/butadiene copolymer; CAS No. 9010-81-5) ; NEP R0601A (based on hydroxy-terminated polydimethylsiloxane; CAS No. 70131-67-8); and NEP R0701 and NEP 0701S (based on butadiene/styrene/2-vinylpyridine copolymer; CAS No. 25053-48-9). Also, those available under the PARALOID tradename, such as PARALOID 2314, PARALOID 2300, and PARALOID 2600, from Dow Chemical Co., Philadelphia, PA, and those available under the STAPHYLOID tradename, such as STAPHYLOID AC-3832, from Ganz Chemical Co., Ltd., Osaka, Japan.

Rubber particles that have been treated with a reactive gas or other reagent to modify the outer surfaces of the particles by, for instance, creating polar groups (e.g., hydroxyl groups, carboxylic acid groups) on the particle surface, are also suitable for use herein. Illustrative reactive gases include, for example, ozone, Cl₂, F₂, O₂, SO₃, and oxidative gases. Methods of surface modifying rubber particles using such reagents are known in the art and are described, for example, in U.S. Pat. Nos. 5,382,635; 5,506,283; 5,693,714; and 5,969,053, each of which being hereby expressly incorporated herein by reference in its entirety. Suitable surface modified rubber particles are also available from commercial sources, such as the rubbers sold under the tradename VISTAMER by Exousia Corporation.

Where the rubber particles are initially provided in dry form, it may be advantageous to ensure that such particles are well dispersed in the adhesive composition prior to curing the adhesive composition. That is, agglomerates of the rubber particles are preferably broken up so as to provide discrete individual rubber particles, which may be accomplished by intimate and thorough mixing of the dry rubber particles with other components of the adhesive composition.

In practice, each of the Part A composition and the Part B composition are housed in separate containment vessels in a device prior to use, where in use the two parts are expressed from the vessels mixed and applied onto a substrate surface. The vessels may be chambers of a dual chambered cartridge, where the separate parts are advanced through the chambers with plungers through an orifice (which may be a common one or adjacent ones) and then through a mixing dispense nozzle. Or the vessels may be coaxial or side-by-side pouches, which may be cut or torn and the contents thereof mixed and applied onto a substrate surface.

The invention will be more readily appreciated by a review of the examples, which follow.

### EXAMPLES

With reference to Table 1, adhesive systems were prepared to evaluate methyl (meth)acrylate-based Part A compositions with a varied amount of either or both of isobornyl acrylate or isobornyl methacrylate with a silane modified polymer-based Part B composition having in all but one instance an oxidant. The Part A composition also included an SIS block copolymer, a reactive acid component and a reducing agent at different amounts and an inhibitor/accelerator package. The Part A composition also included a stabilizer package in the amount of about 1 percent by weight. The adhesive systems in Table 1 vary from 0:1, 1:2, 1:1, 2:1 and 9:1 mix ratio, percent by volume.

TABLE 1

Part A

| Components | | Sample Nos./Amt (wt%) | | | | | | | |
|---|---|---|---|---|---|---|---|---|---|
| Type | Identity | 1 | 2 | 3 | 4 | 5 | 6 | 7 | 8 |
| (Meth)acrylate-functionalized component | MMA | 40.59 | 18.30 | 40.59 | 18.30 | 40.59 | 26.03 | 18.30 | 11.47 |
| Block copolymer | SIS rubber^{!} | 24.30 | 10.95 | 24.30 | 10.95 | 24.30 | 15.59 | 10.95 | 6.87 |
| Alkyl (meth)acrylate component | IBOA | 20.70 | 9.33 | -- | - | 10.35 | 6.64 | 4.67 | 2.93 |
| | IBOMA | -- | - | 20.70 | 9.33 | 10.35 | 6.64 | 4.67 | 2.93 |
| Reactive Acid Component | MA Acid | 0.90 | 0.41 | 0.90 | 0.41 | 0.90 | 0.58 | 0.41 | 0.25 |
| | HARCRYL 1228^{@} | 1.80 | 0.81 | 1.80 | 0.81 | 1.80 | 1.15 | 0.81 | 0.51 |
| Reducing Agent | DMpT^{#} | 0.90 | 0.41 | 0.90 | 0.41 | 0.90 | 0.58 | 0.41 | 0.25 |
| Part A total wt % | | 90.0 | 40.6 | 90.0 | 40.6 | 90.0 | 57.7 | 40.6 | 25.4 |

^{!}KRATON D1114, available commercially from Kraton Corporation and reported by the manufacturer to be a clear, linear block copolymer based on styrene and isoprene with a polystyrene content of 19%. D1114 has a tensile strength of 4600 psi, elongation at break of 1300%, specific gravity of 0.92, and 300% modulus of 270 psi.
@ HARCRYL 1228, available commercially from Harcros Chemicals, Kansas City, KS and reported by the manufacturer to be a unique, functional, acrylic monomer consisting of mono- and di-phosphate esters of 2-Hydroxyethylmethacrylate. The ratio of mono-alkyl to di-alkyl phosphate allows HARCRYL 1228to be easily incorporated into a variety of polymer systems. The polarity of HARCRYL 1228provides for application in hydrophilic formulations as well. The phosphate functional group promotes adhesion to a variety of surfaces, reducing the need for pretreatments.
# DMpT is dimethyl para toluidine.

Part B

| Components | | Sample Nos./Amt (wt%) | | | | | | | | |
|---|---|---|---|---|---|---|---|---|---|---|
| Type | Identity | 0 | 1 | 2 | 3 | 4 | 5 | 6 | 7 | 8 |
| 1k SMP | TEROSTAT MS 939^{$} | 100.0 | - | 54.0 | - | 54.0 | - | 38.4 | 54.0 | 67.8 |
| Oxidant | BPO paste^{%} | - | 10.0 | 5.4 | 10.0 | 5.4 | 10.0 | 3.8 | 5.4 | 6.8 |
| Part B Total wt% | - | 100 | 10.0 | 59.4 | 10.0 | 59.4 | 10.00 | 42.28 | 59.43 | 74.56 |

$ TEROSTAT MS 939, available commercially from Henkel AG & Co. KGaA, Dusseldorf, Germany, is gun-grade, one component sealant based on silane modified polymer, which cures by reaction with moisture to an elastic product. The skin formation and curing times are dependent on humidity and temperature, and the curing time also depends on joint depth. By increasing the temperature and moisture these be reduced; low temeperature as well as low moisture retard the process. TEROSTAT MS 939 particularly sag-resistant leading to a high position tack after matching of the parts to be bonded. TEROSTAT MS 939 is free of solvents, isocyanates, silicones and PVC. It demonstrates good adhesion to many substrates and is comparible with suitable paint systems. The sealant also demonstrates good UV resistance and can therefore be used for interior and exterior applications, TEROSTAT MS 939 demonstrates the strength necessary for elastic bonding. This property of the product also remains at the temperatures in repair ovens (max. 100° C.). TEROSTAT MS 939 shows the product also remains at the temperatures in repair ovens (max. 100° C.). TEROSTAT MS 939 shows no shrinkage, and therefore dimpling and tension stress are not observed under these conditions, TEROSTAT MS 939 allows accelerated curing as two-component material.
% H8000, Part B, available commercially from Henkel Corporation.

The adhesive systems in Table 1 were evaluated for physical properties, including tensile strength and percent elongation, which are shown below in Table 2. Sample No. 0 is TEROSTAT MS 939, in a one part format without a Part A composition.

TABLE 2

| Physical Properties | Sample Nos. | | | | | | | | |
|---|---|---|---|---|---|---|---|---|---|
| | 0 | 1 | 2 | 3 | 4 | 5 | 6 | 7 | 8 |
| Tensile strength @ break 2″/min (psi) | 435 | 2354 | 890 | 2158 | 994 | 2065 | 1348 | 1004 | 522 |
| Elongation @ break 2″/min (%) | 250 | 109 | 304 | 25 | 311 | 87 | 275 | 418 | 449 |

Sample Nos. 2, 4, 6, 7 and 8 show impressive percent elongation values compared to the control samples (Sample No. 0: for a 100% SMP formulation and Sample Nos. 1, 3 and 5 for 100% acrylic formulations).

In Table 3, like Table 1 above, an alkyl (meth)acrylate is present in the Part A composition of the adhesive systems. However, instead of the isobornyl (meth)acrylate (“IBOA”) alone used in the Part A compositions of Table 1, here ethylhexylacrylate (“EHA”) was used with IBOA in two samples and lauryl methacrylate (“LMA”) was used in one. The adhesive systems in Table 3 are in 1:1 mix ratio, percent by volume.

TABLE 3

Part A

| Component | | Sample Nos./Amt (wt%) | | |
|---|---|---|---|---|
| Type | Identity | 9 | 10 | 11 |
| (Meth)acrylate-functionalized component | MMA | 18.30 | 16.63 | 18.30 |
| Block copolymer | SIS rubber^{!} | 10.95 | 9.96 | 10.95 |
| Alkyl (meth)acrylate component | IBOA | 4.67 | 4.24 | |
| | LMA | | | 9.33 |
| | EHA | 4.67 | 4.24 | |
| Reactive Acid Component | MA Acid | 0.41 | 0.37 | 0.41 |
| | HARCRYL1228 | 0.81 | 0.74 | 0.81 |
| Reducing Agent | DMpT | 0.41 | 0.37 | 0.41 |
| Rubber Toughener | Core-shell rubber^{@} | | 3.69 | |
| Part A total wt % | | 40.6 | 40.6 | 40.6 |

! KRATON D1114
@ CLEARSTRENGTH XT100, available commercially from Arkema Inc., Cary, NC and described as a methyl methacrylate-butadiene-styrene core-shell toughening agent, which is compatible with various monomers and easily dispersible in most liquid resin systems, and exhibits a limited impact on their viscosity while providing a toughening effect over a wide range of service temperatures.

Part B

| Component | | Sample Nos. | | |
|---|---|---|---|---|
| Type | Identity | 9 | 10 | 11 |
| 1k SMP | TEROSTAT MS 939 | 54.0 | 54.0 | 54.0 |
| Oxidant | BPO paste^{%} | 5.4 | 5.4 | 5.4 |
| Part B Total wt% | | 59.4 | 59.4 | 59.4 |
| A+B total wt% | | 100 | 100 | 100 |

% H8000, Part B.

The adhesive systems in Table 3 were evaluated for tensile properties, which are shown below in Table 4.

TABLE 4

| Physical Properties | Sample Nos. | | |
|---|---|---|---|
| | 9 | 10 | 11 |
| Tensile strength @ break 2″/min (psi) | 715 | 498 | 439 |
| Elongation @ break 2″/min (%) | 290 | 209 | 328 |

In Table 5, the BPO-amine redox system from Table 1 above was replaced with a TBPB-PDHP/Cu redox system. In addition, one of the Part A compositions here included a filler and one of the Part B compositions included a (meth)acrylate-functionalized component, a SIS copolymer and an alkyl (meth)acrylate component, each of which ordinarily is present only in the Part A composition. The adhesive systems in Table 5 vary from 1:2, 1:1, and 2:1 mix ratio, percent by volume.

TABLE 5

Part A

| Component | | Sample Nos./Amt (wt%) | | | | |
|---|---|---|---|---|---|---|
| Type | Identity | 12 | 13 | 14 | 15 | 16 |
| (Meth)acrylate-functionalized component | MMA | 7.5 | 12.0 | 17.0 | 14.8 | 9.3 |
| Block copolymer | SIS rubber^{%} | 6.4 | 10.3 | 14.6 | 12.7 | 8.0 |
| Alkyl (meth)acrylate component | IBOA | 7.5 | 12.0 | 17.0 | 14.8 | 9.3 |
| Reactive Acid Component | MA Acid | 2.5 | 4.1 | 5.8 | 5.0 | 3.2 |
| | HARCRYL1228 | 0.51 | 0.81 | 1.15 | 1.00 | 0.63 |
| Oxidant | TBPB | 0.8 | 1.2 | 1.7 | 1.5 | 1.4 |
| Filler | CaCOs | | | | | 13.7 |
| Part A total wt % | | 25 | 41 | 58 | 50 | 46 |

% KRATON D1113 P, available commercially from Kraton Corporation and reported by the manufacturer to be a clear, linear block copolymer based on styrene and isoprene with a polystyrene content of 16%. D1113P has a tensile strength of 600 psi, elongation at break of 1500%, specific gravity of 0.92, and 300% modulus of 50 psi.

Part B

| Component | | Sample Nos./Amt (wt%) | | | | |
|---|---|---|---|---|---|---|
| Type | Identity | 12 | 13 | 14 | 15 | 16 |
| 1k SMP | TEROSTAT MS 939 | 70.5 | 56.2 | 40.0 | | 51.4 |
| Transition metal | Cu solution (8% conc.) | 0.37 | 0.30 | 0.21 | 0.25 | 0.27 |
| Reducing Agent | PDHP | 3.7 | 3.0 | 2.1 | 2.5 | 2.7 |
| (Meth)acrylate-functionalized component | MMA | | | | 16.3 | |
| Alkyl (meth)acrylate component | IBOA | | | | 16.3 | |
| Block copolymer | SIS rubber^ | | | | 14.0 | |
| Part B Total wt% | | 75 | 59 | 42 | 50 | 54 |
| A+B total wt% | | 100 | 100 | 100 | 100 | 100 |

^ KRATON D1113 PT, available commercially from Kraton Corporation.

The adhesive systems in Table 5 were evaluated for physical properties, which are shown below in Table 6.

TABLE 6

| Physical Properties | Sample Nos. | | | | | |
|---|---|---|---|---|---|---|
| | 0 | 12 | 13 | 14 | 15 | 16 |
| Tensile strength @ break 2″/min (psi) | 435 | 445 | 787, 877 | 1233 | 2273 | 517 |
| Elongation @ break 2″/min (%) | 250 | 165 | 371 | 228 | 235 | 313 |

Once again, physical properties for Sample No. 0, which is TEROSTAT MS 939 in a one part format without a Part A composition, are shown for comparative purposes. Here, with no acrylic component Sample No. 0 showed a percent elongation of 250. Sample No. 15, a 100% acrylic formulation, demonstrates percent elongation of 235, whereas Sample No. 13 demonstrates a much larger percent elongation, 371. This value is not only higher than the 100% acrylic formulation (Sample No. 15) but also the 100% SMP one (Sample No. 0), which showed a percent elongation of 250. Even when a filler is added (Sample No. 16), the percent elongation is still quite large, 313.

In Table 7, the IBOA from Table 5 was replaced with EHA and EHMA and a TBPB-PDHP/Cu redox system was used together with a SIS copolymer. The adhesive systems in Table 7 are in a 1:1 mix ratio, percent by volume.

TABLE 7

Part A

| Component | | Sample Nos./Amt (wt%) | | | |
|---|---|---|---|---|---|
| Type | Identity | 17 | 18 | 19 | 20 |
| (Meth)acrylate-functionalized component | MMA | 17.5 | 14.4 | 17.5 | 14.4 |
| Block Copolymer | SIS rubber^{&} | 13.5 | 11.1 | 13.5 | 11.1 |
| Alkyl (meth)acrylate component | EHA | 11.5 | 9.4 | | |
| | EHMA | | | 11.5 | 9.4 |
| Reactive Acid Component | MA Acid | 5.0 | 4.1 | 5.0 | 4.1 |
| | HARCRYL1228 | 1.0 | 0.8 | 1.0 | 0.8 |
| Oxidant | TBPB | 1.5 | 1.2 | 1.5 | 1.2 |
| Part A total wt % | | 50 | 41 | 50 | 41 |

& KRATON D1114

Part B

| Component | | Sample Nos./Amt (wt%) | | | |
|---|---|---|---|---|---|
| Type | Identity | 17 | 18 | 19 | 20 |
| 1k SMP | TEROSTAT MS 939 | | 55.76 | | 55.76 |
| Transition metal | Cu solution (8% conc.) | 0.10 | 0.30 | 0.10 | 0.30 |
| Reducing Agent | PDHP | 2.50 | 2.95 | 2.50 | 2.95 |
| (Meth)acrylate-functionalized component | MMA | 22.40 | | 22.40 | |
| Alkyl (meth)acrylate component | EHA | 11.50 | | | |
| | EHMA | | | 11.50 | |
| Block Copolymer | SIS rubber^{!} | 13.50 | | 13.50 | |
| Part B Total wt% | | 50 | 59 | 50 | 59 |
| A+B total wt% | | 100 | 100 | 100 | 100 |

! KRATON D1114

TABLE 8

| Physical Properties | Sample Nos. | | | |
|---|---|---|---|---|
| | 17 | 18 | 19 | 20 |
| Tensile strength @ break 2″/min (psi) | 728 | 684 | 1732 | 679 |
| Elongation @ break 2″/min (%) | 243 | 346 | 206 | 298 |

The adhesive systems in Table 7 without a SMP component in the Part B composition (Sample Nos. 17 and 19) demonstrate percent elongation of 243 and 206, respectively, whereas the adhesive systems with a SMP component in the Part B composition (Sample Nos. 18 and 20) demonstrate percent elongation of 346 and 298, respectively. These latter adhesives systems demonstrate higher percent elongation than adhesive systems based only on a SMP component or a (meth)acrylic component.

In Table 9, a rubber toughener in the form of a liquid rubber (VTB-LC) was included in the Part A compositions and two different block copolymers were evaluated and in two samples the block copolymers were included in the Part B composition too. These adhesive systems use a TBPB-PDHP/Cu redox system. The adhesive systems in Table 9 vary from 1:2, 1:1, and 2:1 mix ratio, and MMA alone, percent by volume.

TABLE 9

Part A

| Component | | Sample Nos./Amt (wt%) | | | | | | | |
|---|---|---|---|---|---|---|---|---|---|
| Type | Identity | 21 | 22 | 23 | 24 | 25 | 26 | 27 | 28 |
| (Meth)acrylate-functionalized component | MMA | 6.7 | 10.6 | 15.1 | 13.1 | 6.7 | 10.6 | 15.1 | 13.1 |
| Block Copolymer | SIS rubber* | | | | | 6.9 | 11.0 | 15.6 | 13.5 |
| | SIS rubber⁽ | 6.9 | 11.0 | 15.6 | 13.5 | | | | |
| Alkyl (meth)acrylate component | IBOA | 5.7 | 9.2 | 13.0 | 11.3 | 5.7 | 9.2 | 13.0 | 11.3 |
| Rubber Toughener | Liquid rubber⁾ | 2.0 | 3.2 | 4.6 | 4.0 | 2.0 | 3.2 | 4.6 | 4.0 |
| Reactive Acid Component | MA Acid | 2.5 | 4.1 | 5.8 | 5.0 | 2.5 | 4.1 | 5.8 | 5.0 |
| | HARCRYL 1228 | 0.51 | 0.81 | 1.15 | 1.00 | 0.51 | 0.81 | 1.15 | 1.00 |
| Additive | Wax 1239A | 0.10 | 0.16 | 0.23 | 0.20 | 0.10 | 0.16 | 0.23 | 0.20 |
| Oxidant | TBPB | 0.8 | 1.2 | 1.7 | 1.5 | 0.8 | 1.2 | 1.7 | 1.5 |
| Part A total wt % | | 25 | 41 | 58 | 50 | 25 | 41 | 58 | 50 |

* KRATON D1113 P
( KRATON D1114
) VTB-LC, available commercially from CVC Thermoset Specialties and reported by the manufacturer to be a low-molecular-weight, methacrylate-functional liquid synthetic rubber. It is a 100%-solids, reactive polymer used primarily as an additive in acrylic adhesives, sealants, coatings and composites. VTB-LC has a viscosity of ^{~}80.000cps, a functionality of 1.9, a molecular weight of 4450, a glass transition temperature of -80° C., and a specific gravity of 0.929.

Part B

| Component | | Sample Nos./Amt (wt%) | | | | | | | |
|---|---|---|---|---|---|---|---|---|---|
| Type | Identity | 21 | 22 | 23 | 24 | 25 | 26 | 27 | 28 |
| 1k SMP | MS 939 | 70.5 | 56.2 | 40.0 | | 70.5 | 56.2 | 40.0 | |
| Transition metal | Cu solution (8% concentration) | 0.37 | 0.30 | 0.21 | 0.25 | 0.37 | 0.30 | 0.21 | 0.25 |
| Reducing Agent | PDHP | 3.7 | 3.0 | 2.1 | 2.5 | 3.7 | 3.0 | 2.1 | 2.5 |
| (Meth)acrylate-functionalized component | MMA | | | | 17.2 | | | | 17.2 |
| Alkyl (meth)acrylate | IBOA | | | | 11.5 | | | | 11.5 |
| Block copolymer | SIS rubber | | | | | | | | 14.0 |
| | SIS rubber⁽ | | | | 14.0 | | | | |
| Rubber toughener | Liquid rubber⁾ | | | | 4.0 | | | | 4.0 |
| Part B Total wt% | | 75 | 59 | 42 | 50 | 75 | 59 | 42 | 50 |
| A+B total wt% | | 100 | 100 | 100 | 100 | 100 | 100 | 100 | 100 |

* KRATON D1113 P
( KRATON D1114
) VTB-LC

As shown in Table 10 below, the adhesive systems of Table 9 without a SMP component in the Part B composition demonstrate a percent elongation of less than about 200. Even Sample No. 0 (with only a SMP component in the Part B composition shown in Tables 1 and 2, and no (meth)acrylic in the Part A composition) shows a better percent elongation — about 250. But the adhesive systems of Table 9 having both an acrylic component in the Part A composition and a SMP component in the Part B composition show a much larger percent elongation — as large as nearly about 500 being reported.

TABLE 10

| Physical Properties | Sample Nos. | | | | | | | |
|---|---|---|---|---|---|---|---|---|
| | 21 | 22 | 23 | 24 | 25 | 26 | 27 | 28 |
| Tensile strength @ break 2″/min (psi) | 820 | 1134 | 1683 | 2437 | 640 | 896 | 1436 | 1552 |
| Elongation @ break 2″/min (%) | 491 | 434 | 439 | 195 | 446 | 322 | 272 | 199 |
| tensile lap shear, Al (1 mm gap, 0.05″/min) | 373 | 694 | 1427 | 2164 | 415 | 452 | 1437 | 1000 |

In Table 11, adhesive systems like those of Table 9 are presented but without IBOA, and the SIS copolymer being replaced with a SBS copolymer. The adhesive systems in Table 11 are in a 1:1 mix ratio, percent by volume.

TABLE 11

Part A

| Component | | Sample Nos./Amt (wt%) | |
|---|---|---|---|
| Type | Identity | 29 | 30 |
| (Meth)acrylate-functional component | MMA | 25.3 | 20.5 |
| Block copolymer | SBS rubber^{!} | 16.9 | 13.7 |
| Reactive Acid Component | MA Acid | 5.0 | 4.1 |
| | HARCRYL 1228 | 1.00 | 0.81 |
| Oxidant | TBPB | 1.5 | 1.2 |
| Part A total wt % | | 50 | 41 |

! KRATON D1155

Part B

| Component | | Sample Nos. | |
|---|---|---|---|
| Type | Identity | 29 | 30 |
| 1k SMP | MS 939 | | 56.1 |
| Transition Metal | Cu solution (8% conc) | 0.10 | 0.30 |
| Reducing Agent | PDHP | 2.5 | 3.0 |
| (Meth)acrylate-functionalized component | MMA | 30.0 | |
| Block copolymer | SBS rubber^{!} | 16.9 | |
| Part B Total wt% | | 50 | 59 |
| A+B total wt% | | 100 | 100 |

! KRATON D1155

Table 12 below shows that the adhesive system of Table 11 without the SMP component in the Part B composition (Sample No. 29) demonstrates a very low percent elongation, 21, but with the SMP component in the Part B composition (Sample No. 30), the percent elongation improves to 154.

TABLE 12

| Physical Properties | Sample Nos. | |
|---|---|---|
| | 29 | 30 |
| Tensile strength @ break 2″/min (psi) | 2383 | 898 |
| Elongation @ break 2″/min (%) | 21 | 154 |

In Table 13, a reactive acidic component is not present in the Part A compositions of the adhesive systems. The adhesive systems are otherwise comparable to those shown in Table 1, Part A, Sample Nos. 5 and 7 above.

TABLE 13

Part A

| Component | | Sample Nos./Amt (wt%) | |
|---|---|---|---|
| Type | Identity | 31 | 32 |
| (Meth)acrylate-functional component | MMA | 43.65 | 19.68 |
| Block copolymer | SIS rubber^{!} | 24.75 | 11.16 |
| Alkyl (meth)acrylate | IBOA | 10.35 | 4.67 |
| | IBOMA | 10.35 | 4.67 |
| Reducing Agent | DMpT | 0.90 | 0.41 |
| Part A total wt % | | 90.0 | 40.6 |

! KRATON D1114

Part B

| Component | | Sample Nos./Amt (wt%) | |
|---|---|---|---|
| Type | Identity | 31 | 32 |
| 1k SMP | MS 939 | | 54.0 |
| Oxidant | BPO paste^{@} | 10.0 | 5.4 |
| Part B Total wt% | | 10.0 | 59.4 |

@ H8000, PART B

Even without a reactive acid component Sample No. 32 still exhibits high percent elongation (428).

TABLE 14

| Physical Properties | Sample Nos. | |
|---|---|---|
| | 31 | 32 |
| Tensile strength @ break 2″/min (psi) | 2144 | 610 |
| Elongation @ break 2″/min (%) | 226 | 428 |

With reference to Table 15, adhesive systems were prepared to evaluate isobornyl acrylate-containing Part A compositions having an oxidant with a silane modified polymer-based Part B composition having a reducing agent. The Part A compositions also included an SIS block copolymer and significantly three of the four samples had a (meth)acrylate-functionalized urethane, such as Resin A, too.

TABLE 15

Part A

| Constituents | | Sample Nos./Amt (wt%) | | | |
|---|---|---|---|---|---|
| Type | Identity | 33 | 34 | 35 | 36 |
| (Meth)acrylate-functionalized component | IBOA | 70 | 65 | 60 | 55 |
| Block copolymer | SIS rubber^{!} | 25 | 22.5 | 20 | 17.5 |
| (Meth)acrylate functionalized urethane | Resin A | -- | 7.5 | 15 | 22.5 |
| Adhesion promoter | Glycidyl 3-(trimethoxy silyl)propyl ether | 1 | 1 | 1 | 1 |
| Catalyst | Dioctyltin -silane complex | 0.5 | 0.5 | 0. 5 | 0.5 |
| Oxidant | 55% Anhydrous benzoyl peroxide phthalate-free formulation^{#} | 2 | 2 | 2 | 2 |
| Part A total wt % | | 98.5 | 98.5 | 98.5 | 98.5 |

^{!}KRATON D1114, available commercially from Kraton Corporation and reported by the manufacturer to be a clear, linear block copolymer based on styrene and isoprene with a polystyrene content of 19%. D1114 has a tensile strength of 4600 psi, elongation at break of 1300%, specific gravity of 0.92, and 300% modulus of 270 psi.
# LUPEROX APF55, available commercially from Arkema inc.

Part B

| Components | | Sample Nos./Amt (wt%) | | | |
|---|---|---|---|---|---|
| Type | Identity | 33 | 34 | 35 | 36 |
| 1k SMP | TEROSTAT MS 939^{$} | 98.68 | 98.68 | 98.68 | 98.68 |
| Reducing Agent | DMpT^{%} | 1.32 | 1.32 | 1.32 | 1.32 |
| Part B total wt% | | 100 | 100 | 100 | 100 |

$ TEROSTAT MS 939, available commercially from Henkel AG & Co. KGaA, Dusseldorf, Germany, is gun-grade, one component sealant based on silane modified polymer, which by with moisture to an elastic product. The skin formation and curing times are dependent on humidity and temperature, and the curing time also depends on joint depth. By increasing the temperature and moisture these times can be reduced; low temperature as well as low moisture retard the process. TEROSTAT MS 939 is particularly sag-resistant leading to a high position tack after matching of the parts to be bonded. TEROSTAT MS 939 is free of solvents, isocyanates, silicones and PVC. It demonstrates good adhesion to many substrates and is compatible with suitable paint systems. The sealant also demonstrates good UV resistance and can therefore be used for interior and exterior applications. TEROSTAT MS 939 demonstrates the strength necessary for elastic bonding. This property of the product also remains at the temperatures in repair ovens (max. 100° C.). TEROSTAT MS 939 shows no shrinkage, and therefore dimpling and tension stress are not observed under these conditions. TEROSTAT MS 939 allows accelerated curing as two-component material.
% DMpT is dimethyl para toluidine.

The adhesive systems in Table 15 were evaluated for physical properties, including fixture time and skin over time, adhesion and tensile properties, and percent elongation, which are shown below in Table 16.

TABLE 16

| Physical Properties | Sample Nos. | | | |
|---|---|---|---|---|
| | 33 | 34 | 35 | 36 |
| Fixture time (min) | 32.5 | 25 | 22.5 | 20 |
| Skinover time (min) | 60 | 45 | 40 | 35 |
| Adhesion (psi) | 193 | 195 | 258 | 291 |
| Tensile strength (psi) | 370 | 363 | 378 | 420 |
| Elongation (%) | 308.0 | 230.0 | 229.0 | 186.5 |

Sample Nos. 34-36 show impressive fixture time and skinover time values compared to the control sample (Sample No. 33, a comparable sample without a (meth)acrylate-functionalized urethane).

Sample Nos. 34-36 also show impressive adhesion, tensile strength and percent elongation values compared to the control sample (Sample No. 33, a comparable sample without a (meth)acrylate-functionalized urethane).

As an additional control, Sample No. 37 is TEROSTAT MS 939, in a one part format without a Part A composition. Sample No. 37 shows tensile strength @ break 2″/min (psi) of 435 and elongation @ break 2″/min (%) of 250.

What is claimed is:

1. A two part adhesive composition comprising:
(a) a Part A composition comprising:
(i) a (meth)acrylate-functionalized component; and
(ii) a block copolymer component; and
(b) a Part B composition comprising:
(i) an alkoxysilane- or acyloxysilane-functionalized component,
wherein the Part A composition or the Part B composition comprises an oxidant and the Part A composition or the Part B composition comprises at least one of a reducing agent and a transition metal, provided that the Part A composition and the Part B composition do not each comprise the oxidant, the reducing agent, and the transition metal.

2. The composition of claim 1, wherein the (meth)acrylate-functionalized component (i) of the Part A composition comprises a mono-functional (meth)acrylate component.

3. The composition of claim 1, wherein the (meth)acrylate-functionalized component (i) of the Part A composition comprises an alkyl(meth)acrylate and/or a mono-functional (meth)acrylate component and one or more of isobornyl (meth)acrylate, lauryl (meth)acrylate and/or ethylhexyl (meth)acrylate.

4. The composition of claim 1, wherein the (meth)acrylate-functionalized component (i) of the Part A composition comprises a mono-functional (meth)acrylate component in an amount within the range of about 10 to about 50 percent by weight.

5. The composition of claim 1, wherein the block copolymer component (ii) of the Part A composition comprises one or more of a (meth)acrylate-terminated polybutadiene in liquid form at room temperature, a styrene-containing block copolymer, a core shell rubber, and combinations thereof.

6. The composition of claim 5, wherein the styrene-containing block copolymer is a member selected from the group consisting of styrene-butadiene-styrene, styrene-isoprene-styrene, and combinations thereof.

7. The composition of claim 5, wherein the styrene-containing block copolymer has a weight average molecular weight in the range of about 100,000 to about 500,000 Mw.

8. The composition of claim 1, further comprising a reactive acid component.

9. The composition of claim 8, wherein the reactive acid component comprises one or more of a (meth)acrylic acid and/or ester thereof.

10. The composition of claim 8, wherein the reactive acid component comprises a phosphate ester of hydroxyethyl methacrylate.

11. The composition of claim 1, wherein the oxidant is a peroxide.

12. The composition of claim 1, wherein the oxidant is a perbenzoate.

13. The composition of claim 1, wherein the oxidant is t-butyl perbenzoate, benzoyl peroxide or cumene hydroperoxide.

14. The composition of claim 1, wherein the oxidant is present in an amount from about 0.01 percent to about 10 percent by weight.

15. The composition of claim 1, wherein the reducing agent is a nitrogen-containing component and/or a transition metal containing compound.

16. The composition of claim 1, wherein the nitrogen containing component is present in an amount from about 0.01 percent to about 10 percent by weight.

17. The composition of claim 15, wherein the transition metal of the transition metal containing compound is a member selected from the group consisting of copper, vanadium, cobalt and iron.

18. The composition of claim 15, wherein the transition metal containing compound is present in an amount from about 0.005 percent by weight to about 0.5 percent by weight.

19. The composition of claim 1, wherein Part A further comprises a reactive acid component.

20. The composition of claim 1, wherein the alkoxysilane-or acyloxysilane-functionalized component is a polymer having at least one hydrolysable silyl group that is bonded to the polymer through an ether (—O—) linking group or carbonyl group, in which the carbonyl group is bonded to heteroatoms selected from oxygen, nitrogen and sulfur, with the proviso that at least one heteroatom is nitrogen.

21. The composition of claim 1, wherein the alkoxysilane-or acyloxysilane-functionalized component is present in an amount from 30 percent by weight to 95 percent by weight.

22. The composition of claim 1, which when mixed together cures to 90% of its ultimate strength in 24 hours at room temperature.

23. The composition of claim 21, which when cured demonstrates at least one of tensile strength on aluminum substrates of greater than 2.5 Mpa, linear shrinkage of less than 8%, Shore A hardness of greater than 40, and elongation of greater than 200%.

24. The composition of claim 1, further comprising an alkyl (meth)acrylate component.

25. The composition of claim 24, wherein the alkyl (meth)acrylate component is selected from the group consisting of polyethylene glycol di(meth)acrylates, tetrahydrofuran (meth)acrylates and di(meth)acrylates, hydroxypropyl (meth)acrylate, hexanediol di(meth)acrylate, trimethylol propane tri(meth)acrylate, diethylene glycol dimethacrylate, triethylene glycol dimethacrylate, benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, bisphenol-F mono and di(meth)acrylates, urethane (meth)acrylate, epoxy(meth)acrylate, and (meth)acrylated polyacrylate.

26. The composition of claim 1, wherein the Part A composition is housed in a first chamber of a dual chamber syringe and the Part B composition is housed in a second chamber of the dual chamber syringe.

27. The composition of claim 1, wherein at least one of the Part A composition or the Part B composition further comprises at least one of a toughener, a plasticizer or a filler.

28. A two part adhesive composition comprising:
(a) a Part A composition comprising:
(i) a (meth)acrylate-functionalized component comprises a mono-functional (meth)acrylate component;
(ii) a (meth)acrylate-functionalized urethane; and
(iii)a block copolymer component; and
(b) a Part B composition comprising:
(i) an alkoxysilane- or acyloxysilane-functionalized component,
wherein the Part A composition or the Part B composition comprises an oxidant and the Part A composition or the Part B composition comprises at least one of a reducing agent and a transition metal, provided that the Part A composition and the Part B composition do not each comprise the oxidant, the reducing agent, and the transition metal.

29. The composition of claim 28, which cures in a fixture time on aluminum substrates with a 1 mm gap of about 15 to about 45 minutes and when cured demonstrates at least one of a tensile strength on aluminum substrates of greater than 2.5 MPa, and percent elongation of greater than 100.
